(19) United States
(12) Patent Application Publication
(10) Pub. No.: US 2026/0054644 A1
(43) Pub. Date: Feb. 26, 2026

(54) VEHICULAR EXTERIOR REARVIEW MIRROR ASSEMBLY WITH INTEGRATED POSITION SENSOR

(71) Applicant: Magna Mirrors of America, Inc., Holland, MI (US)

(72) Inventors: Eric Peterson, West Olive, MI (US); Justin E. Sobecki, Rockford, MI (US)

(21) Appl. No.: 19/304,954

(22) Filed: Aug. 20, 2025

Related U.S. Application Data
(60) Provisional application No. 63/685,296, filed on Aug. 21, 2024.
(60) Provisional application No. 63/707,260, filed on Oct. 15, 2024.
(60) Provisional application No. 63/814,524, filed on May 30, 2025.

(51) Int. Cl. B60R 1/072; B60R 1/12

(52) U.S. Cl. CPC B60R 1/072; B60R 2001/1223

(57) ABSTRACT

A vehicular exterior rearview mirror assembly includes a mirror head adjustable about a mounting structure and an actuator operable to move the mirror head relative to the mounting structure between a folded position and an extended position. A pivot tube extends from the mounting structure and through a base portion of the actuator. A position sensor is disposed at one of a movable portion of the actuator that moves relative to the pivot tube according to movement of the mirror head and a static portion of the actuator that does not move relative to the pivot tube. A magnetic element is disposed at the other one of the movable portion and the static portion. The position sensor senses change in a magnetic field caused by relative movement of the position sensor and the magnetic element for determining a position of the mirror head about the pivot tube.

### CROSS REFERENCE TO RELATED APPLICATIONS

The present application claims the filing benefits of U.S. provisional application Ser. No. 63/814,524, filed May 30, 2025, U.S. provisional application Ser. No. 63/707,260, filed Oct. 15, 2024, and U.S. provisional application Ser. No. 63/685,296, filed Aug. 21, 2024, which are all hereby incorporated herein by reference in their entireties.

### FIELD OF THE INVENTION

The present invention relates generally to the field of rearview mirror assemblies for vehicles and, more particularly, to an exterior rearview mirror assembly that is operable to adjust a rearward field of view of the driver of the vehicle.

### BACKGROUND OF THE INVENTION

Typically, an exterior rearview mirror assembly includes a mirror actuator that is operable to adjust a mirror reflective element relative to the mirror casing so as to adjust a rearward view of the driver of the vehicle. The reflective element and actuator are disposed in the mirror casing and the actuator adjusts the reflective element relative to the mirror casing. Powerfold exterior mirror assemblies include an actuator disposed at a mounting structure that pivots or folds the mirror casing relative to the side of the vehicle.

### SUMMARY OF THE INVENTION

An exterior rearview mirror assembly includes a mirror head adjustable about a mounting structure. The mounting structure is configured to mount the vehicular exterior rearview mirror assembly at a side of a vehicle. The mirror head includes a mirror reflective element. With the vehicular exterior rearview mirror assembly mounted at the side of the vehicle, the mirror head is movable relative to the mounting structure between at least (i) an extended position where the mirror head is extended outward from the side of the vehicle so that the mirror reflective element is positioned to provide a rearward view at the side of the vehicle to a driver of the vehicle and (ii) a folded position where the mirror head is folded inward from the extended position toward the side of the vehicle. The mirror head accommodates an actuator. With the vehicular exterior rearview mirror assembly mounted at the side of the vehicle, the actuator is electrically operable to move the mirror head relative to the mounting structure between the folded position and the extended position. The actuator includes a detent mechanism that, when engaged, retains the mirror head in the extended position or the folded position. A pivot tube extends from the mounting structure and through a base portion of the actuator. When the mirror head is moved between the extended position and the folded position, the mirror head moves about a longitudinal axis of the pivot tube. When the mirror head is moved from the extended position toward the folded position, the mirror head moves along the longitudinal axis of the pivot tube away from the mounting structure and the base portion of the actuator. An induction sensor is disposed at a movable portion of the actuator. When the mirror head is moved between the extended position and the folded position, the induction sensor and the movable portion of the actuator move relative to the longitudinal axis of the pivot tube according to movement of the mirror head relative to the longitudinal axis of the pivot tube. A magnet is disposed at a static portion of the actuator. When the mirror head is moved between the extended position and the folded position, the magnet and the static portion of the actuator do not move relative to the longitudinal axis of the pivot tube. The induction sensor senses a magnetic field of the magnet for determining a position of the mirror head about the longitudinal axis of the pivot tube.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicular exterior rearview mirror assembly;

FIG. 2 is a plan view of the exterior rearview mirror assembly with the mirror head in an extended position relative to mounting base;

FIG. 3 is a plan view of the exterior rearview mirror assembly with the mirror head in a folded position relative to the mounting base;

FIG. 4 is a sectional view of an actuator of the exterior rearview mirror assembly with a magnet disposed at a base portion of the pivot assembly and an induction sensor disposed within the actuator housing, where the magnet and the induction sensor are spaced from one another in a direction parallel to the pivot axis of the mirror assembly;

FIG. 5 is a sectional view of the actuator with the magnet disposed at the base portion and the induction sensor disposed within the actuator housing, where the magnet and the induction sensor are spaced from one another in a direction perpendicular to the pivot axis of the mirror assembly;

FIG. 6 is a sectional view of the actuator with the magnet disposed at a retainer flange of the pivot assembly and the induction sensor disposed within the actuator housing, where the magnet and the induction sensor are spaced from one another in a direction parallel to the pivot axis of the mirror assembly;

FIG. 7 is a sectional view of the actuator with the magnet disposed at the retainer flange of the pivot assembly and the induction sensor disposed within the actuator housing, where the magnet and the induction sensor are spaced from one another in a direction perpendicular to the pivot axis of the mirror assembly;

FIG. 8 is a schematic diagram showing movement of the induction sensor relative to the magnet during movement of the mirror head when the induction sensor and the magnet are spaced from one another in the direction parallel to the pivot axis of the mirror assembly;

FIG. 9 shows sensor readings of the induction sensor during movement of the mirror head when the induction sensor and the magnet are spaced from one another in the direction parallel to the pivot axis of the mirror assembly;

FIG. 10 is a schematic diagram showing movement of the induction sensor relative to the magnet during movement of the mirror head when the induction sensor and the magnet are spaced from one another in the direction perpendicular to the pivot axis of the mirror assembly;

FIG. 11 shows sensor readings of the induction sensor during movement of the mirror head when the induction sensor and the magnet are spaced from one another in the direction perpendicular to the pivot axis of the mirror assembly;

FIGS. 12 and 13 are schematic diagrams of the actuator where signals generated by the induction sensor are transmitted to an electronic control unit (ECU) disposed remote from the actuator for processing;

FIG. 14 is a schematic diagram of the actuator where signals generated by the induction sensor are processed at a processor of the actuator and transmitted as discrete signals to the remote ECU;

FIGS. 15 and 16 are schematic diagrams of the actuator where signals generated by the induction sensor are processed at the processor of the actuator and transmitted as analog signals to the remote ECU;

FIG. 17 is a chart of the signal transmitted to the remote ECU according to SENT protocols;

FIG. 18 includes charts of the signals generated by the induction sensor during movement of the mirror head;

FIG. 19 is a chart of valid and invalid signals transmitted to the remote ECU during movement of the mirror head;

FIG. 20 is a perspective view of the base portion of the pivot assembly with the magnet oriented at the base portion so that the magnetic poles of the magnet are oriented axially relative to the induction sensor;

FIG. 21 is a perspective view of the base portion of the pivot assembly with the magnet oriented at the base portion so that the magnetic poles of the magnet are oriented tangentially relative to the induction sensor;

FIG. 22 is a perspective view of the actuator having the base portion of FIG. 21;

FIG. 23 is a top view of the actuator of FIG. 22;

FIG. 24 is a bottom view of the actuator of FIG. 22;

FIG. 24A is a sectional view taken along line A-A in FIG. 24;

FIG. 25 is a side view of the actuator of FIG. 22;

FIG. 25A is a sectional view taken along line A-A of FIG. 25;

FIG. 25B is a sectional view taken along line B-B of FIG. 25; and

FIG. 26 is a plan view of a printed circuit board of the actuator of FIG. 22.

### DESCRIPTION OF THE PREFERRED EMBODIMENTS

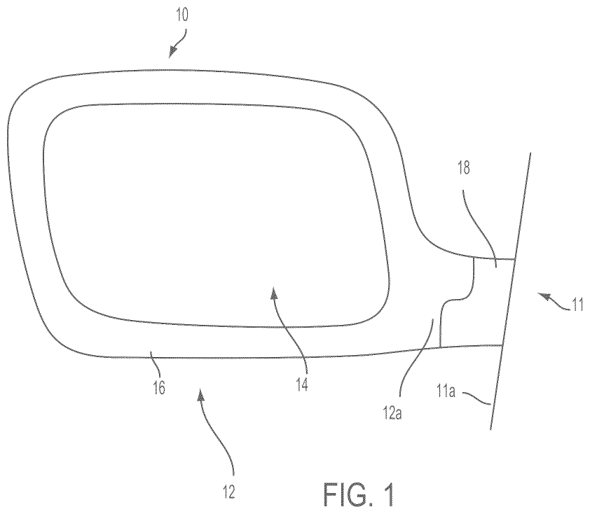

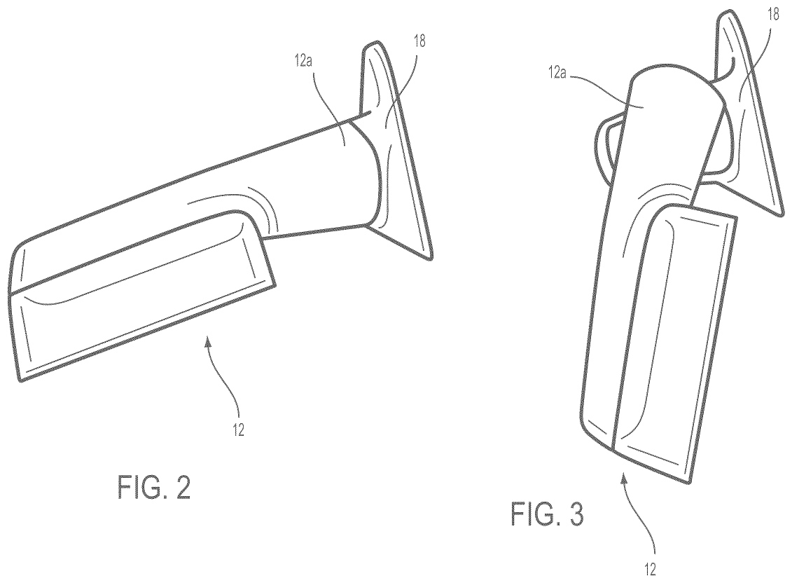

Referring now to the drawings and the illustrative embodiments depicted therein, an exterior rearview mirror assembly 10 for a vehicle 11 includes a mirror head 12 that includes a mirror reflective element 14 received in and/or supported at or by a mirror shell or casing 16 of the mirror head portion 12 (FIG. 1). The mirror head portion 12 includes a mounting portion 12a that is pivotally or movably mounted to a mounting arm or base or portion 18. The mirror assembly 10 comprises a powerfold mirror (where the mirror head portion may be pivoted via an actuator assembly or adjustment device), and may comprise a breakaway mirror (where the mirror head portion may be manually pivoted about the mounting arm or base). The mounting arm or base 18 of the mirror assembly 10 is mounted at the side 11a of a host or subject vehicle 11 equipped with the mirror assembly 10, with the reflective element 14 providing a rearward field of view along the respective side of the vehicle to the driver of the vehicle, as discussed below.

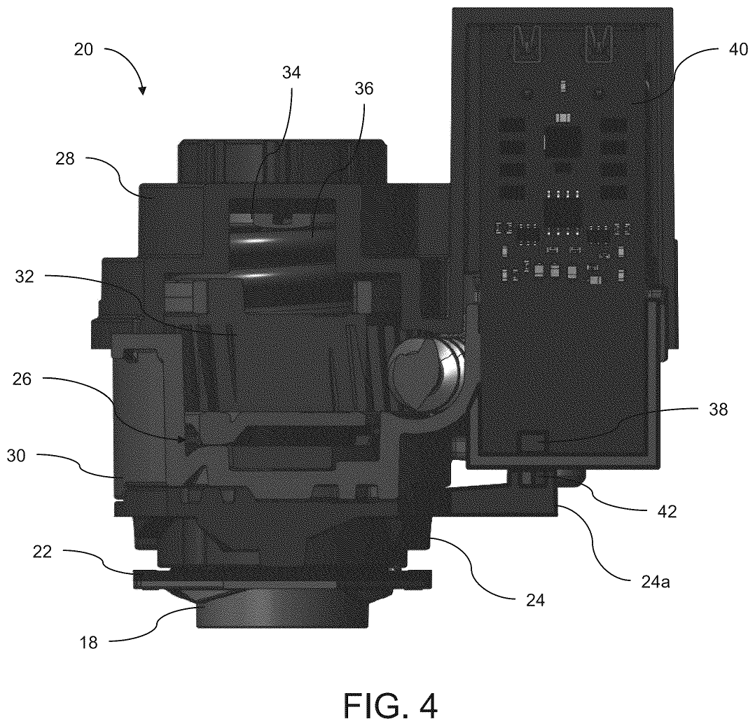

The powerfold mirror assembly 10 includes an actuator 20 (FIG. 4) that is operable to pivot the mirror head 12 (comprising the mirror casing 16 and reflective element 14) relative to the mounting arm or base 18. The actuator 20 operates, such as responsive to a user input, to pivot the mirror head 12 between a plurality of detent positions, including a use or drive position (FIG. 2) and a folded or park position (FIG. 3). The mirror head 12 is also pivotable manually to either the use or folded position. The actuator 20 may pivot the mirror head 12 between the drive position and the folded position responsive to the user input, or the actuator 20 may pivot the mirror head 12 automatically, such as upon completion of performance of a parking maneuver of the vehicle 11 or upon locking or unlocking of the doors of the vehicle 11.

When in the use or drive position, the mirror head 12 is extended from the side 11a of the vehicle 11 so as to provide the rearward field of view along the side 11a of the vehicle 11 to the driver of the vehicle 11. When in the folded or park position, the mirror head 12 is folded or pivoted or rotated from the extended position toward the side 11a of the vehicle 11, such that the mirror reflective element 14 may be facing the side 11a of the vehicle 11 and does not provide the rearward field of view along the side 11a of the vehicle 11. Optionally, the mirror head 12 may also be pivoted to a fully forward position, where the mirror head 12 is folded or pivoted or rotated away from the folded position and beyond the use position, such that the mirror reflective element 14 may face sideward or forward away from the vehicle 11. The mirror head 12 may pivot toward the fully forward position manually, such as upon contact or a collision with an object. A seal may be disposed along the interface between the mounting portion 12a of the mirror head 12 and the mounting arm or base 18, such as to reduce noise or damage from vibration of the mirror head 12 relative to the mounting base 18 and/or to preclude moisture or debris from entering the mirror head 12 or mounting base 18.

The actuator 20 includes a pivot assembly that has a base post construction that is fixedly disposed at or attached at the mounting base 18 and that has a pivot tube or post 22 and a base 24 integrated together (or that has a separate base and pivot post joined together), with the pivot post 22 providing or defining a pivot axis for the mirror head 12 when the mirror head 12 is pivoted relative to the side of the vehicle 11 between at least the folded position, the use position, and the fully forward position. The post 22 extends from the mounting base 18 and extends through a detent assembly 26 of the actuator 20. A rotatable portion of the actuator 20 (e.g., a first or upper housing portion 28, a second or lower housing portion 30 and/or an output gear 32 of the actuator) is pivotally fixed relative to the mirror head 12 so that, as the rotatable portion pivots about the pivot post 22, the mirror head 12 pivots about the pivot post 22 relative to the mounting base 18. The detent assembly 26 enables axial movement of the actuator 20 and mirror head 12 along the pivot post 22 as the mirror head 12 pivots about the pivot post 22 between the detent positions. For example, as the mirror head 12 is moved between the folded and use positions, the mirror head 12 and mounting portion 12a may separate from or lift relative to the mounting base 18 to reduce pressure on the seal disposed therebetween.

A retainer 34 is rigidly fastened to the post 22 or integrally formed as a flared end of the post 22, such that the retainer 34, post 22, and base 24 are effectively a single member or element and provide axial and rotational ground reference for all motions and forces. A spring or biasing element 36 is disposed between the retainer 34 and an upper surface of the actuator 20 (e.g., an upper surface of the detent assembly or housing of the actuator) and urges or biases the detent assembly 26 into engagement. The actuator 20 may utilize aspects of the actuators described in U.S. Pat. Nos. 11,396,264; 11,173,843; 10,099,618; 9,827,913; 9,487,142; 9,346,403; 9,067,541 and/or 7,887,202, and/or U.S. Publication Nos. US-2023-0009664; US-2022-0126751; US-2021-0261053; US-2020-0353867 and/or US-2020-0223364, which are all hereby incorporated herein by reference in their entireties.

In some examples, a camera or other sensor (such as a radar sensor, lidar sensor, ultrasonic sensor, and the like) is disposed at the mirror head 12 for capturing sensor data representative of regions exterior of the vehicle. For example, with the mirror head in the extended position, the camera may capture image data representative of a region that is at least along the side of the vehicle and that is processed as part of a surround view camera system or camera monitoring system (CMS) of the vehicle. Optionally, sensor data may be processed for an advanced driver assistance system (ADAS) of the vehicle, such as for a lane keep assist function or a blind spot monitoring function. Because the mirror head 12 is movable between the folded position and the extended position, misalignment of the mirror head 12 at the extended position (e.g., due to mechanical drift over the lifecycle of the mirror assembly, due to manufacturing tolerances in the mirror assembly, due to damage to the mirror assembly and the like) can cause errors in processing of the captured sensor data.

Referring to FIGS. 4-13, the exterior rearview mirror assembly 10 includes a sensor 38, such as a 3D Hall effect sensor or an induction sensor, that is operable to detect a position of the mirror head 12 relative to the mounting base 18. The sensor 38 may be fixed relative to the mirror head 12 and thus move with the mirror head 12 relative to the mounting base 18, and the sensor 38 senses movement relative to a fixed or non-rotatable portion of the mirror assembly for detecting position of the mirror head 12. For example, the sensor 38 is integrated with the actuator 20 for determining a position of the mirror head 12 between the folded position and the extended position, and/or for determining a degree of misalignment or relative distance of the mirror head 12 from the folded position or extended position. The sensor 38 may detect the position of the mirror head 12 relative to the base 18 based on a detected position of the actuator housing relative to the base 22. The sensor 38 precisely detects the position of the mirror head 12 relative to the mounting base 18 for assisting mirror head-mounted camera performance. For example, the ADAS and/or CMS of the vehicle may calibrate the image data captured by the camera at the mirror head based on the determined position of the mirror head.

As shown in FIG. 4, the actuator 20 includes a printed circuit board (PCB) 40 that is accommodated by the actuator housing. That is the PCB 40 is disposed between the upper housing portion 28 and the lower housing portion 30 and moves with the actuator housing as the mirror head moves between positions. The sensor 38 may comprise a Hall effect sensor disposed at the PCB 40 that detects the position of the mirror head 12 relative to the mounting base 18 based on sensing a magnet 42 that is disposed at the base 24 and that does not move as the mirror head moves between positions. The Hall effect sensor may be at the movable part or the static part and may sense the magnetic field of the magnet at the other of the movable part or the static part. Based on differences in the magnetic field sensed by the Hall effect sensor (e.g., differences in strength of the magnetic field and/or differences in polarity or direction of the magnetic field), movement of the mirror head 12 relative to the mounting base 18 is determined. The PCB 40 may include a connecting portion, such as a 5-6 pin connector/header, for electrically connecting to a wiring harness of the vehicle and transmitting signals from the sensor 38. Optionally, the sensor may comprise an induction sensor at the movable part or the static part that generates a magnetic field and that senses changes in its own magnetic field when the magnetic field encounters a magnet (or other metallic object) at the other of the movable part or the static part. For example, the induction sensor includes an inductive coil that is electrically charged to generate the magnetic field and the sensor senses changes in the inductance of the inductive coil to determine a position of the magnetic or metallic object relative to the sensor. Based on these sensed changes, movement of the mirror head 12 relative to the mounting base 18 is determined.

In the illustrated example, the PCB 40 is vertically oriented within the actuator housing so that a longitudinal axis of the PCB 40 is generally parallel to a pivot axis of the actuator 20 that extends along the longitudinal axis of the pivot tube 22 and radially spaced from the pivot tube 22. A lateral axis of the PCB 40 extends perpendicular to and may intersect the pivot axis of the actuator 20. The sensor 38 is disposed at a side of the PCB 40 at an end region of the PCB 40 nearest the base 24. The base 24 may include a tab or extension portion 24a that extends radially outward from the pivot tube 22 and along a lower end or surface of the lower housing portion 30, and the magnet 42 may be disposed at the extension 24a.

The magnet 42 may be integrally formed with or otherwise suitably attached to the base 24. For example, the magnet 42 may be press fit at a recessed portion of the extension 24a and/or adhesively attached to the base 24 via a glue or other adhesive material or the magnet 42 may be overmolded by a nonmagnetic material of the base 24, such as during an injection molding process of forming the base 24. Further, because the magnet 42 may be at least partially exposed to the environment at the base 24, a potting material or other sealant may be disposed at or over the magnet 42. With the magnet 42 fixed relative to the base 24 and the mirror base 18, the sensor 38 moves with the actuator housing and the mirror head 12 relative to the magnet 42. A gap in the direction parallel to the longitudinal axis of the pivot tube 22 may be disposed between the magnet 42 and the sensor 38 due to the lower housing portion 30 and to accommodate movement of the housing relative to the magnet 42.

The magnet 42 may be vertically aligned with the sensor 38 and spaced from the sensor 38 in the direction parallel to the longitudinal axis of the pivot tube 22. In other words, with the mirror head 12 in a known position (e.g., the extended position), the magnet 42 and the sensor 38 may be aligned with one another in the direction parallel to the pivot axis of the actuator 20, with the sensor 38 disposed above the magnet 42. As the mirror head 12 and the actuator housing pivot about the pivot axis of the pivot tube 22, the sensor 38 moves with the actuator housing relative to the magnet 42. The sensor 38 may pivot about the pivot axis and/or move axially along the pivot axis relative to the magnet 42 according to movement of the mirror head 12. Based on changes in the sensed magnetic field, the system determines movement of the sensor 38 and the mirror head 12 about the pivot axis and in axial directions along the pivot axis. That is, the Hall effect sensor senses differences in the magnetic field of the magnet 42 at different positions of the magnet 42 relative to the Hall effect sensor or the induction sensor senses changes in its generated magnetic field caused by movement of the magnet or metallic element relative to the induction sensor.

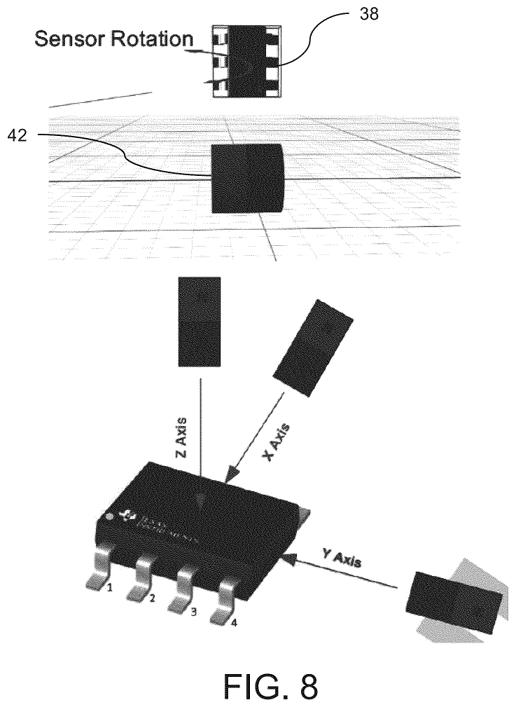

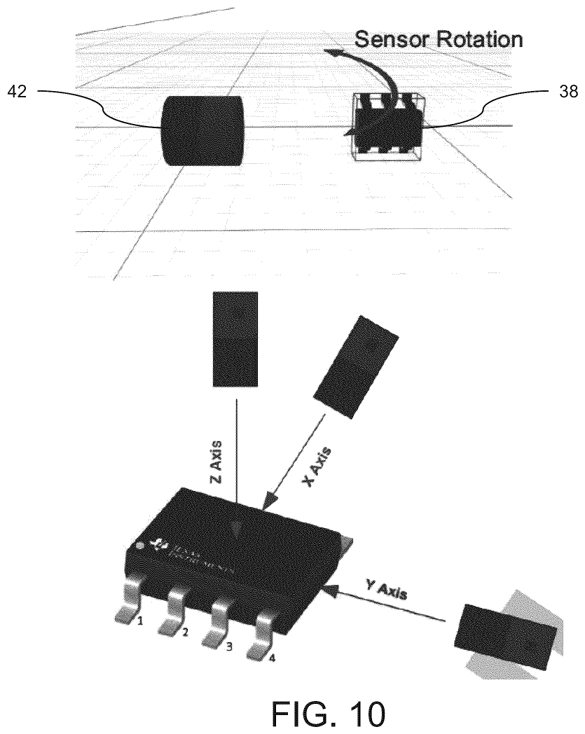

For example, a 3D Hall effect sensor may measure the field strength of the axial magnet in orthogonal directions (bₓ, b_{y} and b_{z}) (FIGS. 8 and 10). The inverse tangent of the measured values may provide an angular measurement of the sensor-magnet system. Because the sensor is significantly eccentric to the axis of rotation, the calculated value (θₛₑₙₛₒᵣ) may not be the true actuator angle (θ_{actuator}), but may be mapped around the home position using a first conversion constant (k₁), as represented by:

$${θ}_{actuator} = {k}_{1} * {tan}^{- 1} \frac{{b}_{y}}{{b}_{z}}$$

The measurement may be accurate when the magnitude of the magnetic field is greater than a specified minimum (bₘᵢₙ), as represented by:

$$\sqrt{{b}_{x}^{2} + {b}_{y}^{2} + {b}_{z}^{2}} \geq {b}_{min}$$

Further, the magnitude of the magnetic field may be used to determine the proximity of the magnet 42 (d_{magnet}) to the sensor 38 using a second conversion constant (k₂), such as represented by:

$${d}_{m a g n e t} = {k}_{2} \sqrt{{b}_{x}^{2} + {b}_{y}^{2} + {b}_{z}^{2}}$$

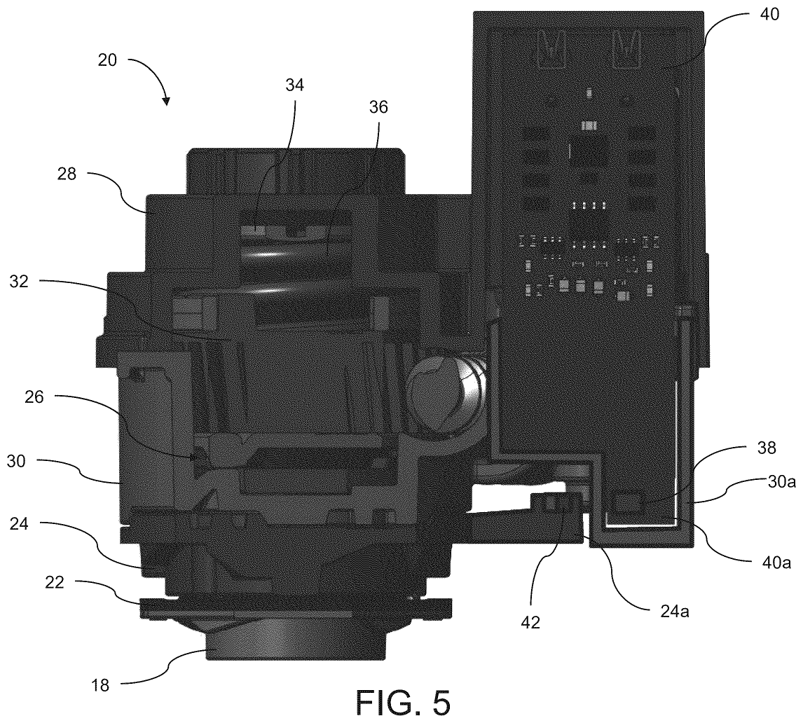

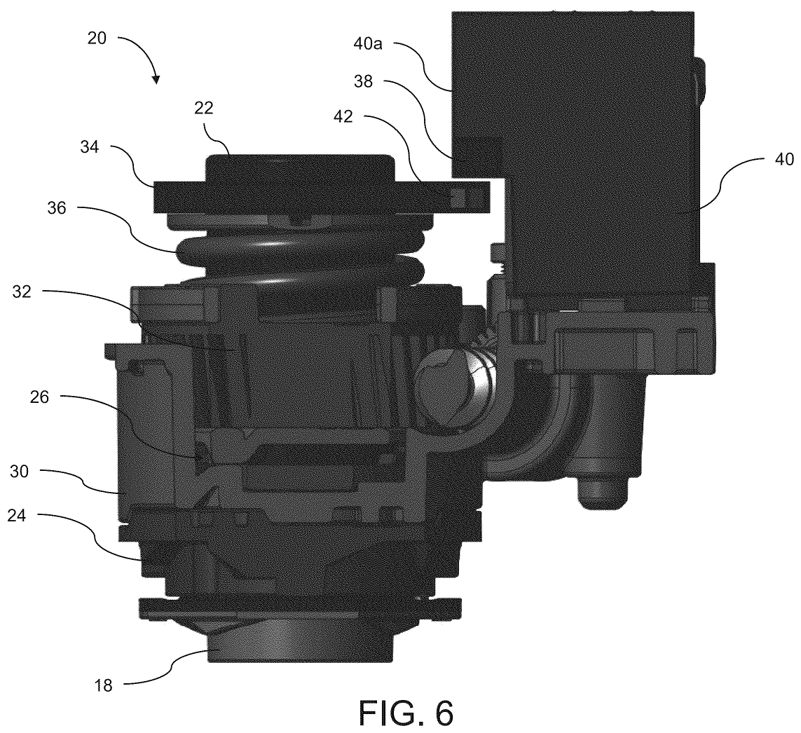

In some examples, the magnet and the sensor may be aligned with one another along a plane that is transverse (e.g., perpendicular) to the axis of rotation. In other words, and such as shown in FIG. 5, with the mirror head 12 in a known position (e.g., the extended position), the magnet 42, the sensor 38 and the pivot axis may be aligned with one another in a horizontal direction perpendicular to the pivot axis of the actuator 20, with the sensor 38 spaced from and disposed radially outboard of the magnet 42. As the mirror head 12 and the actuator housing pivot about the pivot axis of the pivot tube 22, the sensor 38 moves with the actuator housing relative to the magnet 42. The sensor 38 may pivot about the pivot axis and/or move axially along the pivot axis relative to the magnet 42. Based on changes in the sensed magnetic field, the system determines movement of the sensor 38 and the mirror head 12 about the pivot axis and in axial directions along the pivot axis.

In the illustrated example of FIG. 5, the lower housing portion 30 includes a tab portion or extension portion 30a that extends axially toward the mirror base 18 and is disposed radially outboard of the extension 24a of the base 24. The PCB 40 includes a tab portion or extension portion 40a that extends within the extension portion 30a of the lower housing portion 30 so that, with the sensor 38 disposed at the extension portion 40a of the PCB 40, the sensor 38 may be coplanar with the magnet 42 at the extension 24a of the base 24. That is, the sensor 38 and the magnet 42 are spaced from another along the plane that is perpendicular to the pivot axis.

Optionally, the magnet 42 may be disposed within the actuator housing at a fixed or non-rotatable portion of the actuator 20 and the sensor 38 may be disposed within the actuator 20 at a rotatable portion of the actuator 20 that moves with the mirror head 12. Referring to FIG. 6, the magnet 42 may be disposed at the retainer 34 at the upper end of the pivot post 22, with the sensor 38 configured to sense movement of the actuator housing relative to the magnet 42 at the retainer 34. The magnet 42 may be integrally formed with or otherwise suitably attached to the retainer 34. For example, the magnet 42 may be press fit at a recessed portion of the retainer 34 and/or adhesively attached to the retainer 34 via a glue or other adhesive material. The retainer 34 may be fixed or integrally formed with the pivot tube 22, with the pivot tube 22 fixed relative to the mirror base 18. The sensor 38 rotates about the pivot axis and/or moves axially along the pivot axis with the actuator housing and the mirror head 12 to determine movement of the mirror head relative to the sensor 38 and the mirror base 18.

In the illustrated example of FIG. 6, the extension portion 40a of the PCB 40 may extend above and over and along at least a portion of the retainer 34. The sensor 38 is disposed at the extension portion 40a of the PCB 40 and vertically aligned with the magnet 42 at the retainer 34. In other words, with the mirror head 12 in a known position (e.g., the extended position), the magnet 42 and the sensor 38 may be spaced from and aligned with one another in a direction parallel to the pivot axis of the actuator 20, with the sensor 38 disposed above the magnet 42. As the mirror head 12 and the actuator housing pivot about the pivot axis of the pivot tube 22, the sensor 38 moves with the actuator housing relative to the magnet 42. The sensor 38 may pivot about the pivot axis and/or move axially along the pivot axis relative to the magnet 42. Based on changes in the sensed magnetic field, the system determines movement of the sensor 38 and the mirror head 12 about the pivot axis and in axial directions along the pivot axis.

Because the sensor 38 and the magnet 42 are both disposed within the actuator housing in the illustrated example of FIG. 6, there may be a smaller gap between the sensor 38 and magnet 42. However, the extension portion 40a of the PCB 40 and position of the sensor 38 above the retainer 34 may require a larger packaging space within the upper housing portion 28. Proximity of the magnet 42 and sensor 38 to the biasing element 36 and the pivot tube 22 may affect the magnetic field.

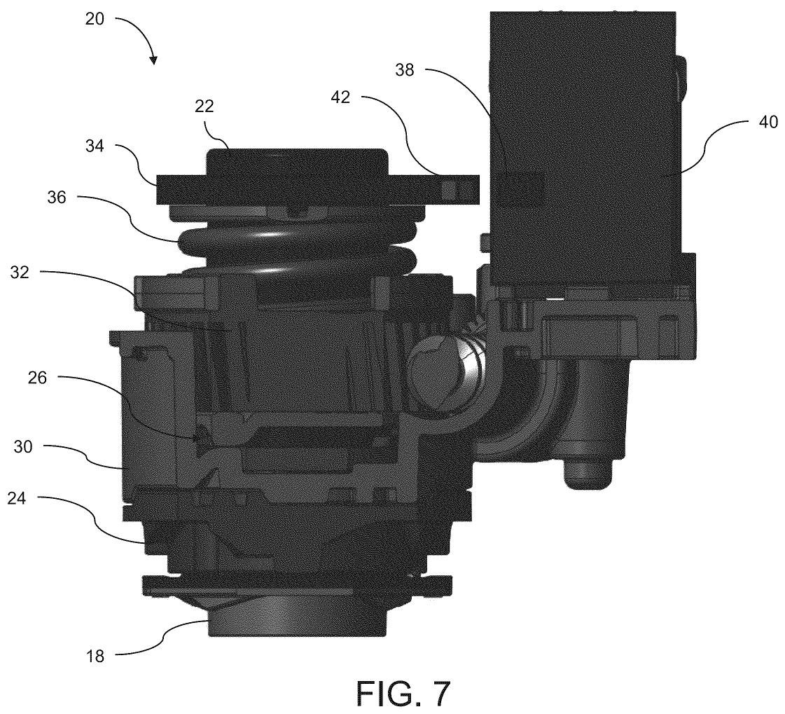

Optionally, the magnet and the sensor may be disposed within the actuator housing and aligned with one another along a plane that is transverse (e.g., perpendicular) to the axis of rotation. In other words, and such as shown in FIG. 7, with the mirror head 12 in a known position (e.g., the extended position), the magnet 42, the sensor 38 and the pivot axis may be aligned with one another in a horizontal direction perpendicular to the pivot axis of the actuator 20, with the sensor 38 spaced from and disposed radially outboard of the magnet 42. In the illustrated example, the magnet 42 is disposed at the retainer 34 and the PCB 40 extends within the actuator housing and along an outer edge of the retainer 34. The sensor 38 is disposed at the PCB 40 radially outboard of the retainer 34 so that the sensor 38 may be coplanar with the magnet 42.

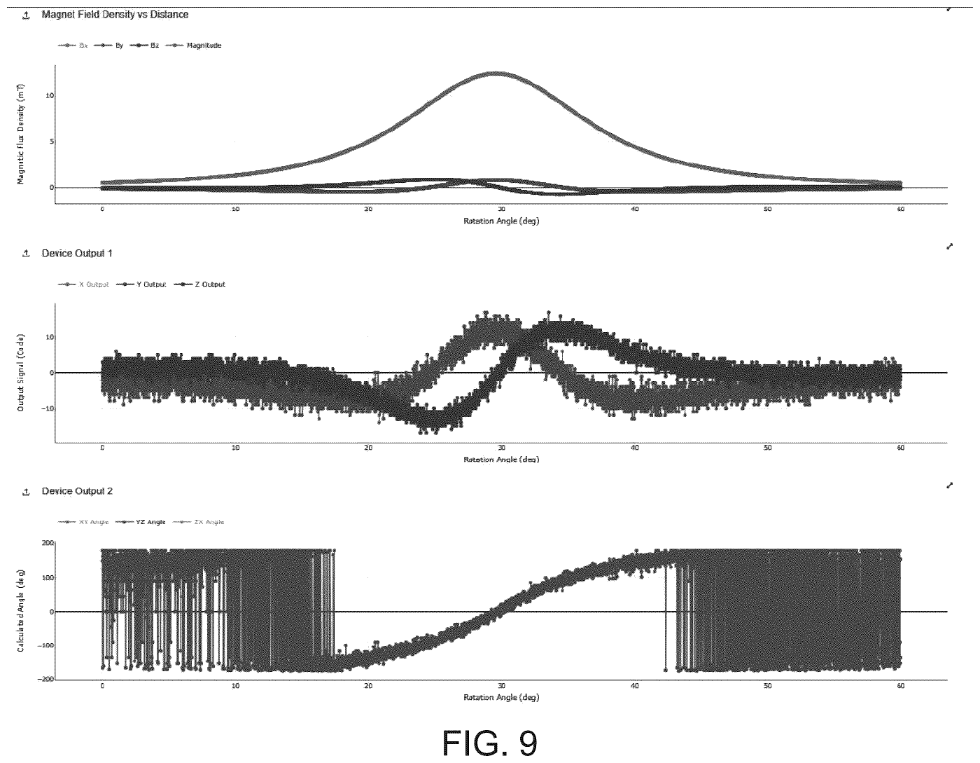

As shown in FIGS. 8 and 9, with the sensor 38 and magnet 42 spaced from one another in a direction parallel to the pivot axis of the mirror head 12 (and optionally aligned with one another in the extended position or the folded position), and with the sensor 38 disposed at the side of the vertically oriented PCB 40 (e.g., FIGS. 4 and 6), movement of the mirror head 12 about the pivot axis may cause the sensor 38 to detect changes in the magnetic field in a Y-direction (parallel to the pivot axis) and a Z-direction (perpendicular to the pivot axis and in the direction of movement of the mirror head). Thus, based on changes in sensed magnetic flux density in the Y-direction and the Z-direction, the system may determine the rotation angle of the mirror head 12 about the pivot axis (e.g., relative to the extended position or the folded position).

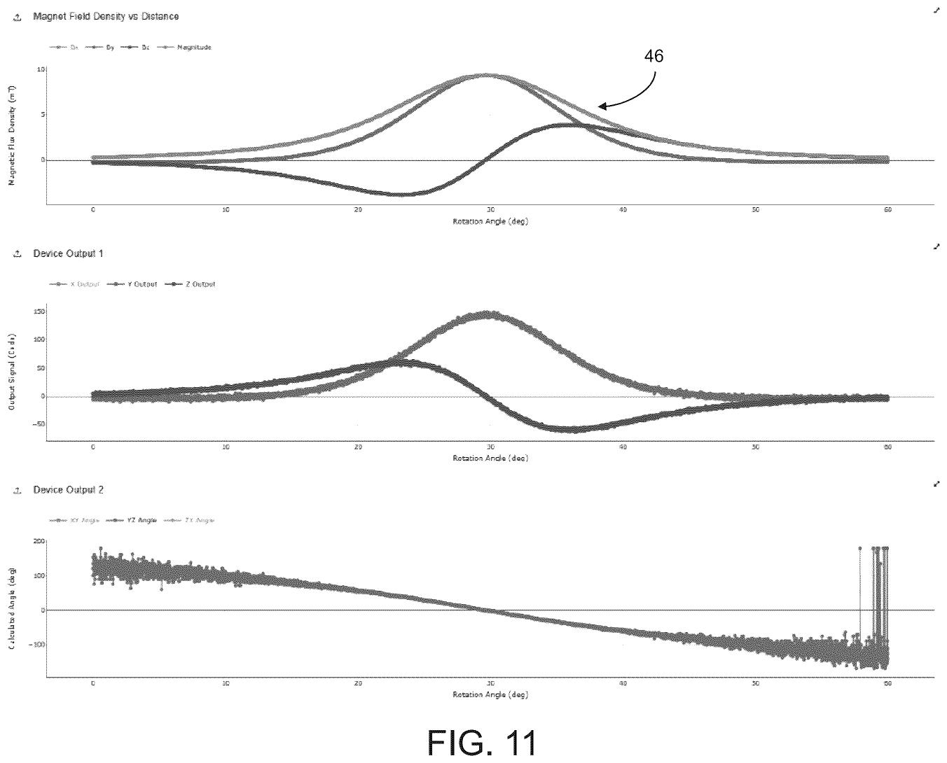

As shown in FIGS. 10 and 11, with the sensor 38 and magnet 42 spaced from one another in a direction perpendicular to the pivot axis of the mirror head 12 (and optionally aligned with one another and the pivot axis in the extended position or the folded position), and with the sensor 38 disposed at the side of the vertically oriented PCB 40 (e.g., FIGS. 5 and 7), movement of the mirror head 12 about the pivot axis may cause the sensor 38 to detect changes in the magnetic field in a Y-direction (perpendicular to the pivot axis and perpendicular to the direction of movement of the mirror head) and a Z-direction (perpendicular to the pivot axis and in the direction of movement of the mirror head). Thus, based on changes in sensed magnetic flux density in the Y-direction and the Z-direction, the system may determine the rotation angle of the mirror head about the pivot axis (e.g., relative to the extended position or the folded position). The planar or horizontal alignment of the sensor 38 and magnet 42 may produce a less noisy signal 46 with a better signal-to-noise ratio (SNR) over a wider angular range of the mirror head (FIG. 11).

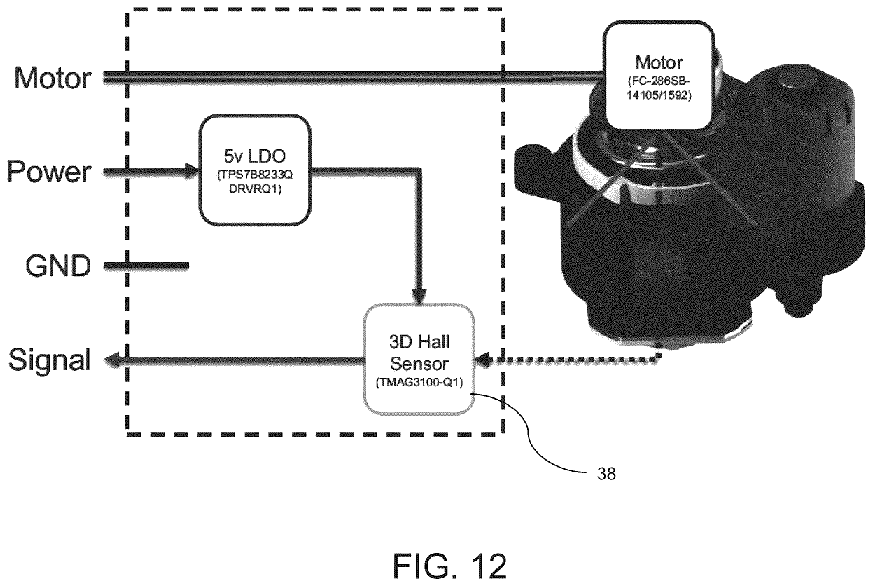

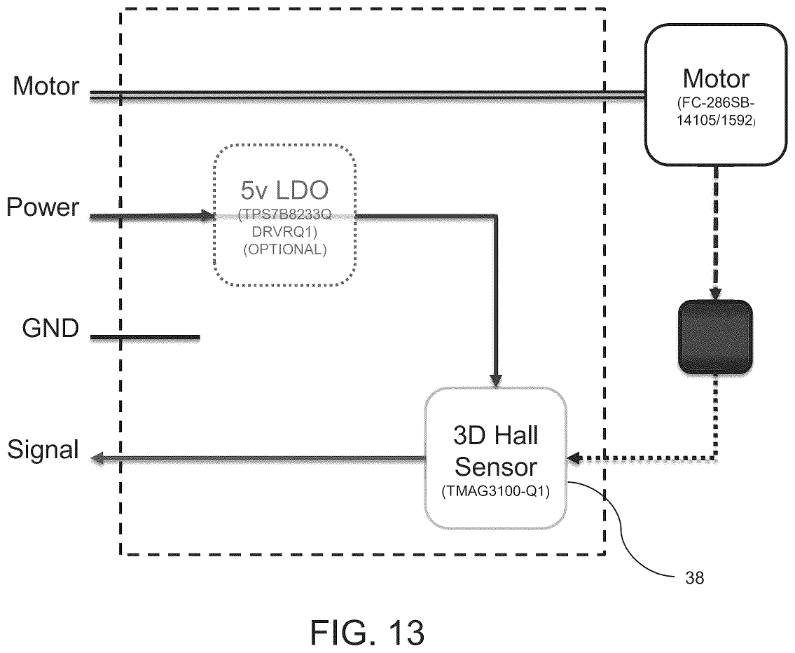

In some examples, and such as shown in FIG. 12, signals 46 from the sensor 38 may be transmitted to an external electronic control unit (ECU) or control module for processing. In other words, the actuator 20 may output the sensor signal and processing may occur at the external ECU. For example, the external ECU may include electronic circuitry and software associated with the ADAS of the vehicle and the sensor data from the sensor 38 may be processed at the ECU as part of an ADAS function, such as to determine positioning of an object relative to the vehicle where the object is detected in image data captured by the camera at the mirror head 12 and determination is based on the rotational position of the mirror head 12 relative to the mounting base 18. Power to the sensor 38 may be provided via a 5 volt low-dropout regulator (LDO) (FIG. 12) or power may be provided directly to the sensor 38 (FIG. 13).

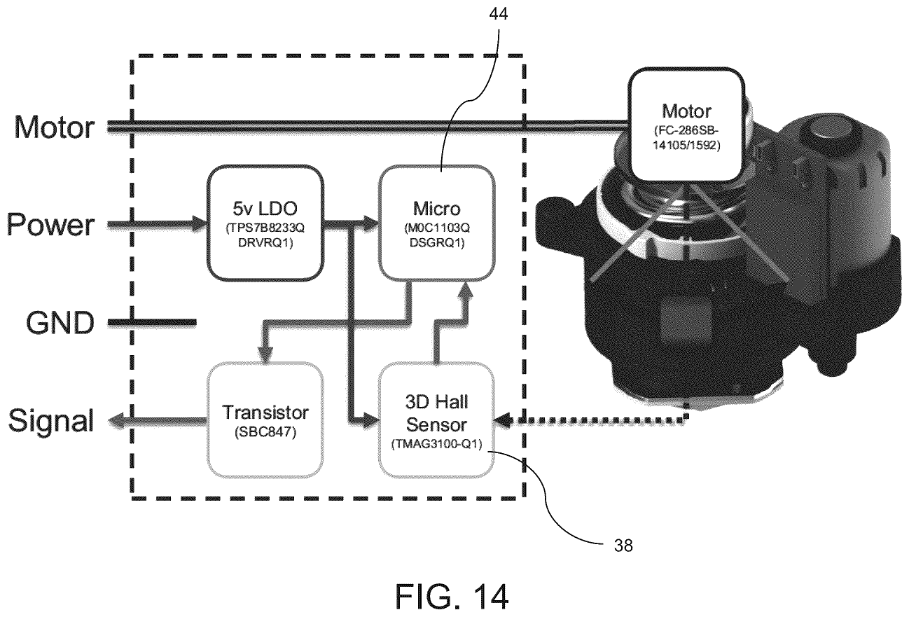

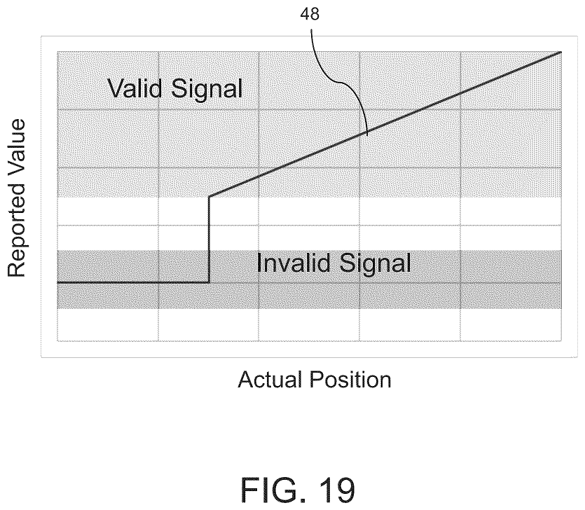

Optionally, and such as shown in FIG. 14, the actuator 20 may include an ECU or a processor or microprocessor 44, such as at the PCB 40, that processes the sensor data captured by the sensor 38. Thus, the actuator 20, via processing of the sensor data, may convert the captured sensor data to a position and transmit a signal 48 representative of the relative position of the actuator and mirror head 12 (e.g., FIG. 19). For example, the actuator 20 may output the determined position of the mirror head to the ADAS so that processing of the captured image data may be based on the determined position of the mirror head. The microprocessor 44 and the sensor 38 may receive power via a 5 volt LDO.

In some examples, the microprocessor 44 may act as a discrete switch and thus transmit the signal 48 via a transistor based on determination that the actuator 20 and mirror head are in the extended position or folded position (FIG. 14). That is, the validity of the signals 46 from the sensor 38 and the determination that the actuator 20 and the mirror head are in the extended position or folded position may occur on-board at the actuator 20, with the signal 48 sent to the ADAS indicating that the mirror head is in the extended position and/or folded position.

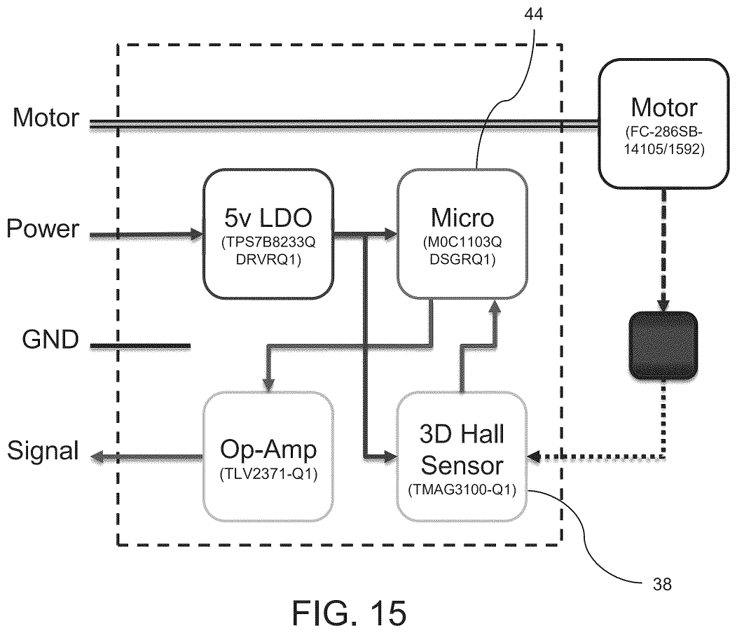

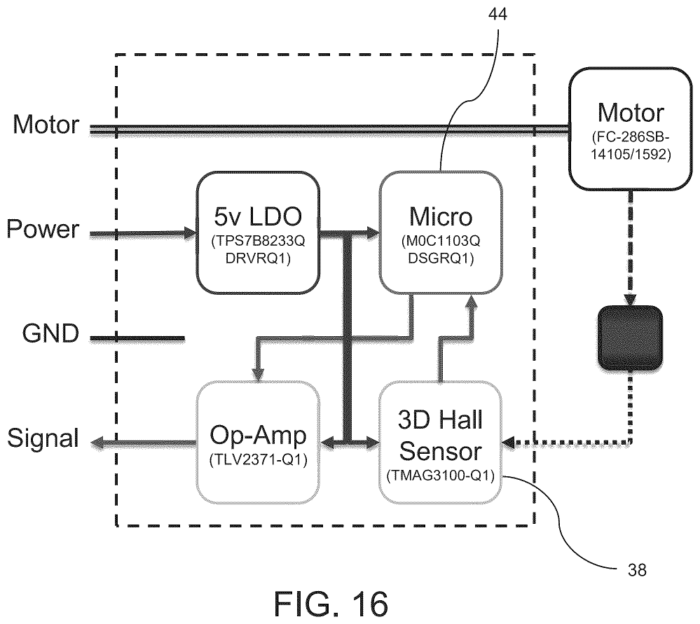

Optionally, the microprocessor 44 may act as an analog switch and thus transmit the signal 48 via an operational amplifier (op-amp) based on the determined position of the actuator and mirror head between the extended position and the folded position, where the op-amp may vary the signal 48 based on communication with the microprocessor 44 (FIG. 15) and optionally based on communication with the sensor 38 (FIG. 16). That is, the validity of the signals 46 from the sensor 38 and the determination that the actuator 20 and the mirror head are in the extended position or the folded position may occur on-board at the actuator 20, with the signal 48 sent to the ADAS indicating the position of the mirror head between the extended position and the folded position.

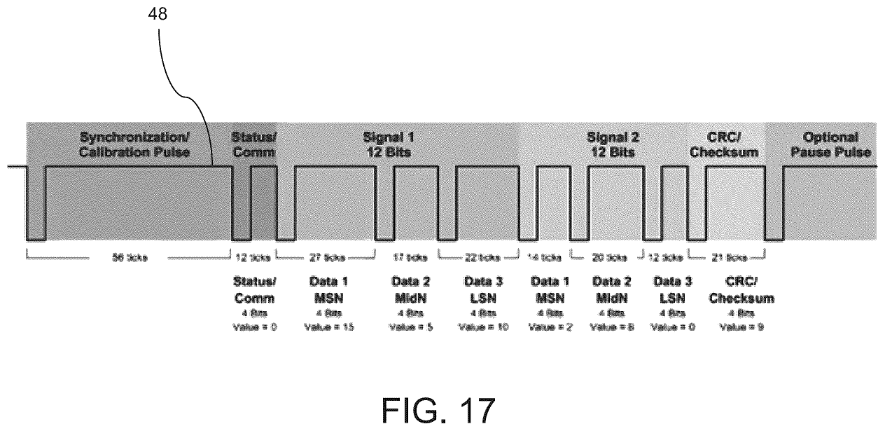

Optionally, and such as shown in FIG. 17, the signal 48 from the actuator 20 may be transmitted via single edge nibble transmission (SENT) output protocol as an automotive standard signal. These signals may include 16-bit calculated angle and magnitude signals.

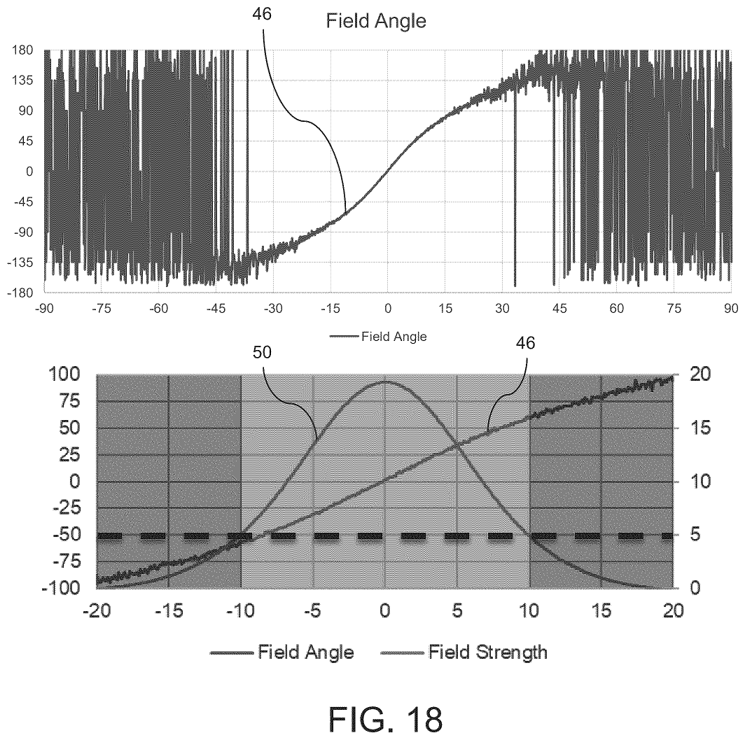

As shown in FIGS. 18 and 19, the position of the actuator 20 and the mirror head relative to the magnet 42 may be tracked within a range that is based on the signals 46 generated by the sensor 38. That is, as the sensor 38 and the magnet 42 move away from one another, the SNR may degrade and become unusable. Thus, an out-of-range signal or invalid signal output may be provided from the microprocessor 44 when the mirror head moves out of range of the sensor 38, such as at the folded position, and the actuator 20 may only transmit the position of the mirror head when the signal 46 from the sensor 38 is valid. The sensor 38 may produce reliable signals (e.g., based on the magnetic field of the magnet 42 or based on the magnetic field generated by the induction sensor) within a range of +10 degrees to −10 degrees, +15 degrees to −15 degrees, +30 degrees to −30 degrees, and the like (e.g., relative to a home or default or extended position of the mirror head). Optionally, the reliable or valid field of sensing of the sensor 38 may be limited based on the determined field strength 50. In other words, as the sensor 38 and the magnet 42 move away from one another, the relative strength of the magnetic field (e.g., the magnetic field of the magnet or the generated magnetic field of the induction sensor) decreases and the determined position of the mirror head 12 may become less reliable.

Thus, based on the sensor data generated by the sensor 38, the position of the mirror head 12 relative to the mounting base 18 (e.g., relative to the extended position or the folded position) may be determined at a relatively high resolution. For example, the rotational position of the mirror head 12 may be determined within 5 degrees or less, within 1 degree or less, within 0.3 degrees or less, within 0.2 degrees or less, within 0.1 degrees or less and the like. Over the life cycle of the actuator 20, the mirror head 12 may experience mechanical drift of 0.25 degrees or less, 0.2 degrees or less, 0.1 degrees or less and the like.

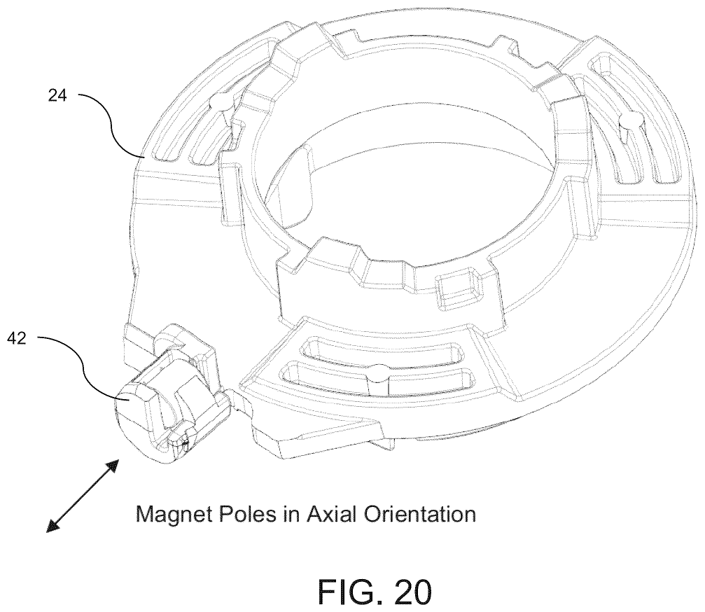

Further, orientation of the magnetic poles of the magnet 42 relative to the sensor 38 may affect the strength of the magnetic field sensed by the sensor 38 and/or the effect of the magnet 42 on the magnetic field generated by the induction sensor, and thus the signal to noise ratio and position detection accuracy of the system. For example, and referring to FIGS. 5 and 20, the magnetic poles of the magnet 42 may be disposed at the base portion 24 of the actuator 20 such that the poles are oriented axially relative to the sensor 38. That is, with the mirror head in a given position (e.g., a home or extended position), the sensor 38 and north and south poles of the magnet 42 may be aligned along an axis that is perpendicular to the pivot axis of the actuator 20 (FIG. 20). As the mirror head and sensor 38 pivot relative to the magnet 42, an angle of the sensor 38 relative to the axis extending through the north and south poles of the magnet 42 (as measured about the pivot axis of the actuator 20) may change.

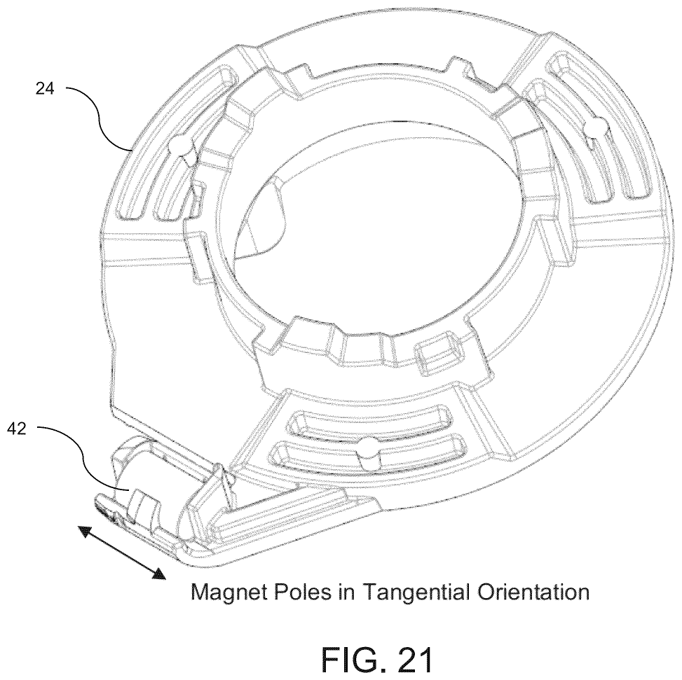

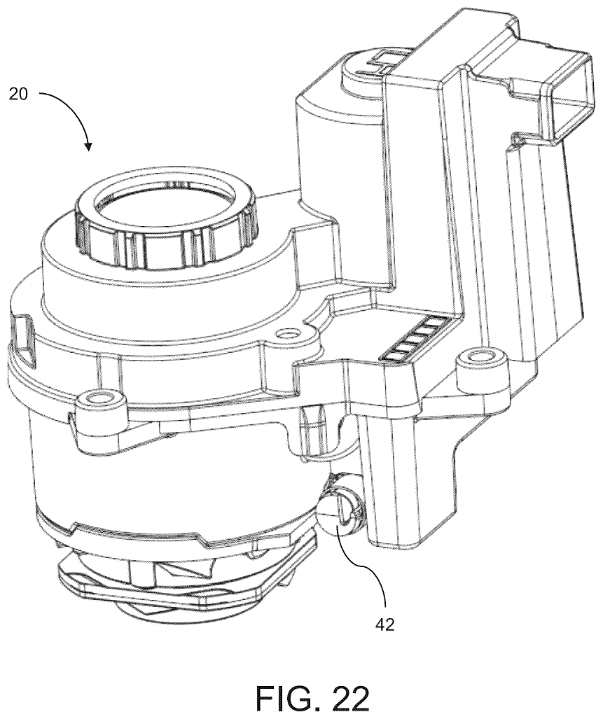

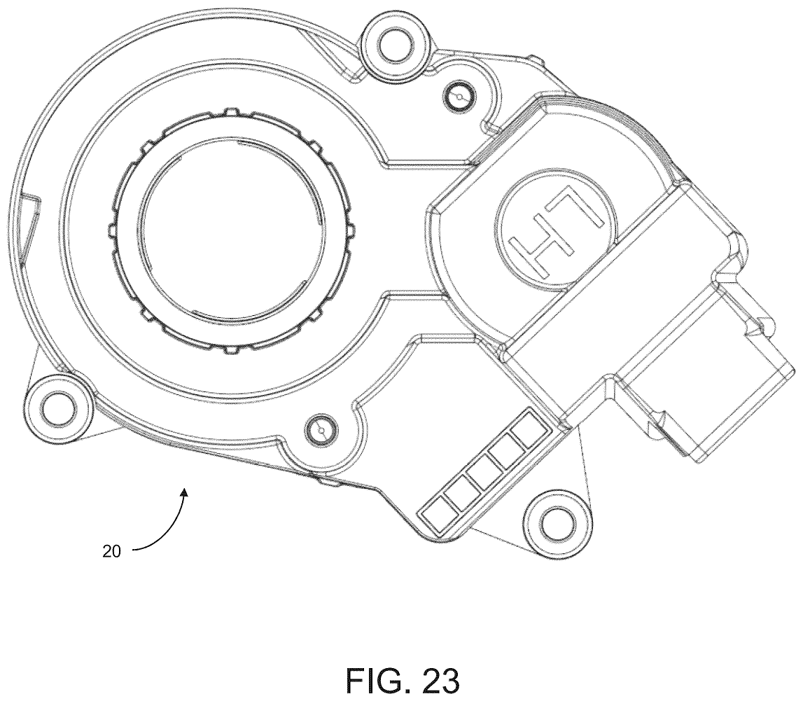

Referring to FIGS. 5 and 21-26, the magnetic poles of the magnet 42 may be disposed at the base portion 24 such that the poles are oriented tangentially relative to the sensor 38. In other words, the north and south poles of the magnet 42 may be aligned with one another along an axis that is perpendicular and offset from the pivot axis of the actuator and tangential (or slightly offset from) a path of motion of the sensor 38 and mirror head about the pivot axis (FIG. 21). Thus, with the mirror head in a given position (e.g., a home or extended position), the magnet 42 may be disposed adjacent to the sensor 38 and, as the mirror head and sensor 38 move relative to the magnet 42, the sensor 38 may pass through or cross the axis extending through the north and south poles of the magnet 42. Orienting the magnetic poles of the magnet 42 tangential to the sensor 38 may provide a stronger magnetic field, therefore reducing signal to noise ratio and improve position detection accuracy.

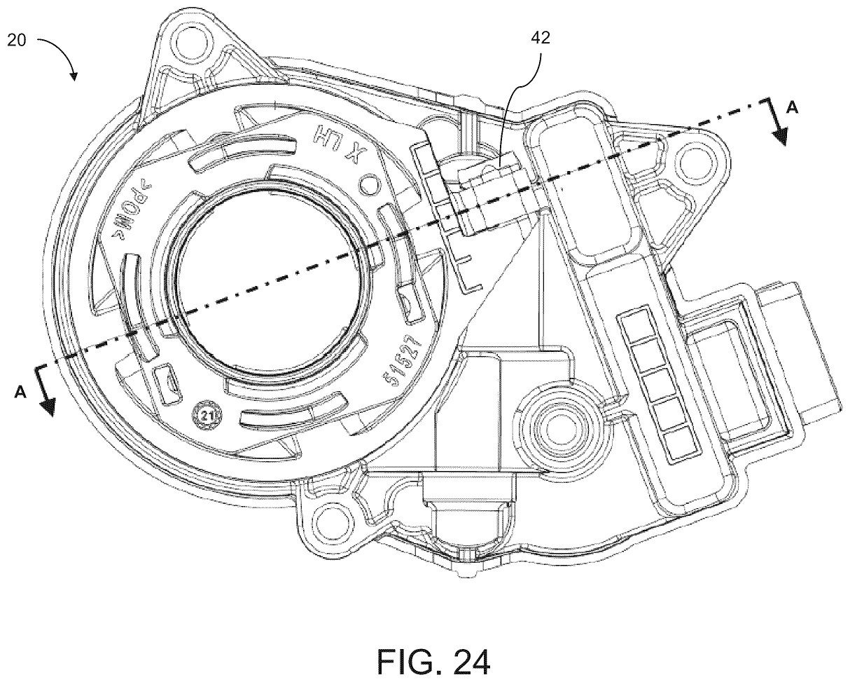

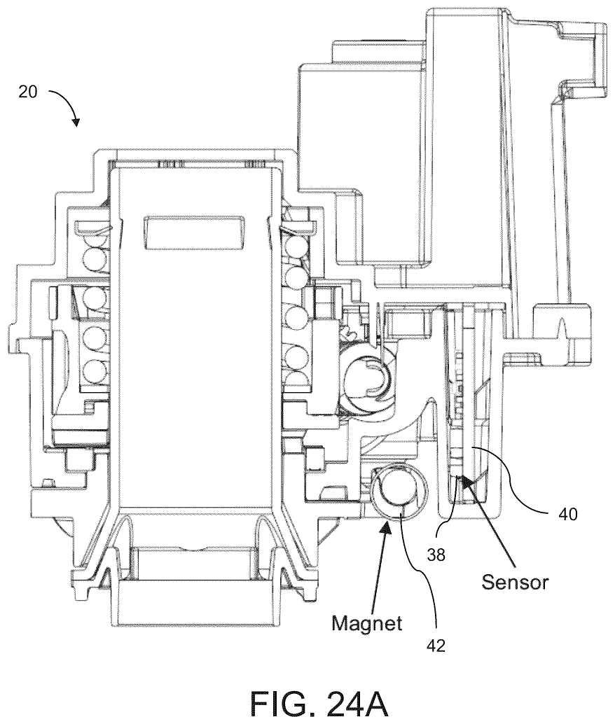

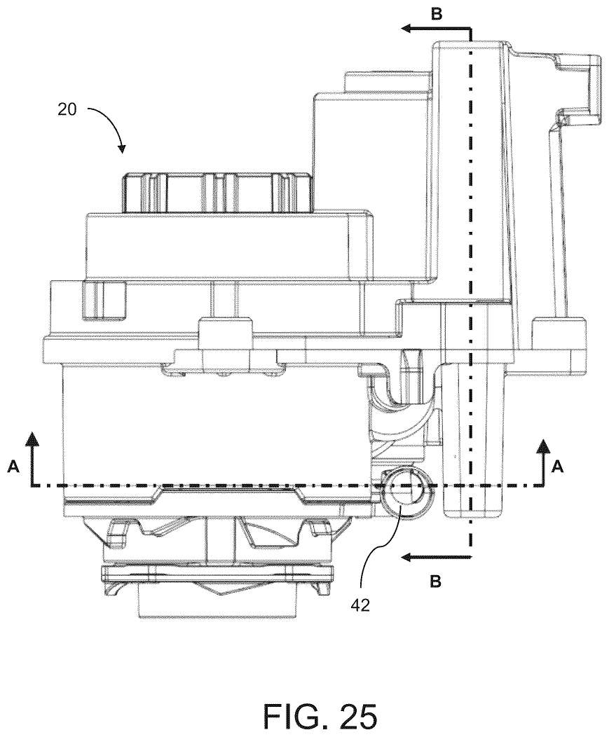

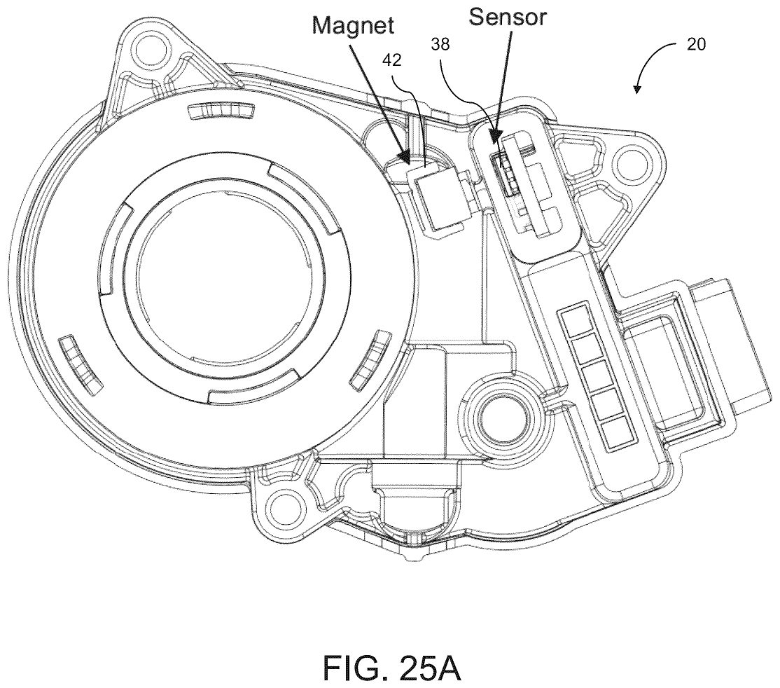

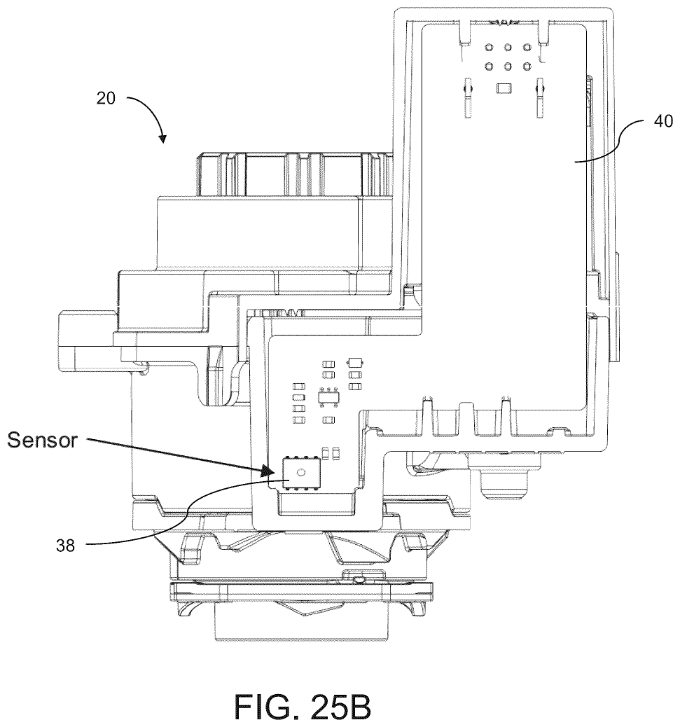

Moreover, and as shown in FIGS. 24A and 25A, the PCB 40 may be vertically oriented within the actuator housing so that the longitudinal axis of the PCB 40 is generally parallel to the pivot axis of the actuator 20 and the lateral axis of the PCB 40 extends perpendicular to the pivot axis and optionally offset from the pivot axis. That is, the lateral axis of the PCB 40 extends tangential to the path of motion of the actuator 20 and the mirror head. The sensor 38 is disposed at a side of the PCB 40 that faces the magnet 42 and the pivot axis of the actuator 20.

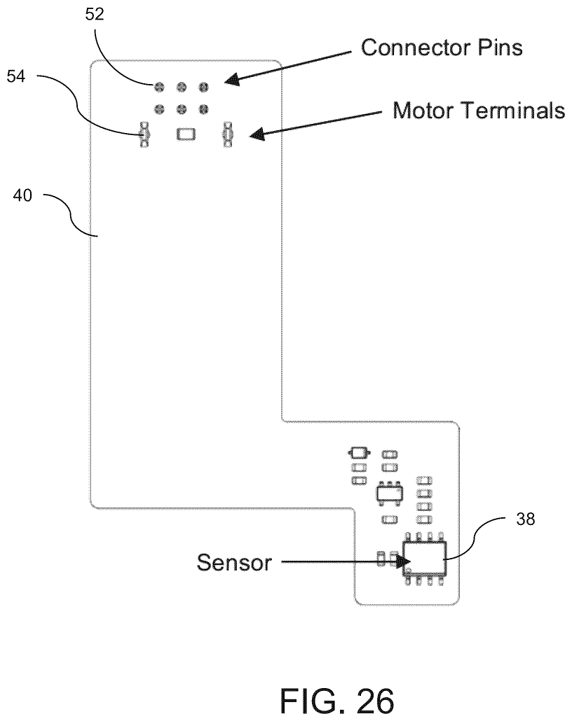

As shown in FIG. 26, the PCB 40 may include a connector 52, such as a 6-pin connector, for connecting to the working harness of the vehicle. Terminals 54 may be disposed at the PCB 40 for electrically connecting to the motor of the actuator 20.

Based on determination that the position of the mirror head 12 is outside an acceptable range (e.g., that the position of the mirror head is further than a threshold distance from the extended position or the folded position), the system may attempt to fold and extend the mirror head 12 to an acceptable position. In other words, responsive to movement of the mirror head 12 toward the extended position and based on determination that the mirror head 12 has stopped in a position that is further from the extended position than is allowable, the system may move the mirror head 12 to the folded position and then move the mirror head toward the extended position once again. Optionally, the system may generate an alert to the driver indicative of the mirror head positioning error, such as to prompt the driver to cycle the mirror or manually move the mirror head to the extended position.

During processing of image data captured by the camera at the mirror head 12, and based on determination that the mirror head 12 is further than a threshold distance from the extended position or the folded position, the system may adjust operation of the ADAS or adjust processing of the captured image data. For example, the ADAS may reduce a confidence level associated with the image data captured by the camera and/or stop relying on image data captured by the camera.

The mirror assembly may utilize aspects of the mirror assemblies described in U.S. Publication Nos. US-2021-0331625; US-2021-0316664; US-2021-0213880; US-2020-0353867 and/or US-2020-0223364, and/or U.S. Pat. Nos. 11,325,535; 10,099,618; 9,827,913; 9,487,142; 9,346,403 and/or 8,915,601, which are all hereby incorporated herein by reference in their entireties.

Optionally, the mirror assembly may include an imaging sensor (such as a sideward and/or rearward facing imaging sensor or camera that has a sideward/rearward field of view at the side of the vehicle at which the exterior mirror assembly is mounted) that may be part of or may provide an image output for a vehicle vision system, such as a lane departure warning system or object detection system or blind zone alert system or surround view vision system other vehicle vision system or the like, and may utilize aspects of various imaging sensors or imaging array sensors or cameras or the like, such as a CMOS imaging array sensor, a CCD sensor or other sensors or the like, such as by utilizing aspects of the imaging systems described in U.S. Pat. Nos. 7,038,577; 6,882,287; 6,198,409; 5,929,786; 5,786,772; 7,881,496 and/or 7,720,580, and/or of the reverse or backup aid systems, such as the rearwardly directed vehicle vision systems described in U.S. Pat. Nos. 5,550,677; 5,760,962; 5,670,935; 6,201,642; 6,396,397; 6,498,620; 6,717,610 6,757,109 and/or 7,005,974, and/or of the automatic headlamp controls described in U.S. Pat. Nos. 5,796,094; 5,715,093 and/or 7,526,103, and/or of the rain sensors described in U.S. Pat. Nos. 6,250,148 and 6,341,523, and/or of other imaging systems, such as the types described in U.S. Pat. Nos. 6,353,392 and 6,313,454, which may utilize various imaging sensors or imaging array sensors or cameras or the like, such as a CMOS imaging array sensor, a CCD sensor or other sensors or the like, such as the types disclosed in commonly assigned, U.S. Pat. Nos. 8,982,273; 6,097,023; 5,796,094; 5,760,962 and/or 5,550,677, which are all hereby incorporated herein by reference in their entireties.

Optionally, the mirror assembly and camera or sensor may be integrated with a camera monitoring system (CMS) of the vehicle. The integrated vehicle system incorporates multiple inputs, such as from an inward viewing or driver monitoring camera and from a forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The CMS cameras and system may utilize aspects of the systems described in U.S. Pat. No. 11,242,008 and/or U.S. Publication Nos. US-2021-0162926; US-2021-0155167; US-2018-0134217 and/or US-2014-0285666, and/or International Publication No. WO 2022/150826, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in in U.S. Pat. Nos. 11,242,008; 10,442,360 and/or 10,046,706, and/or U.S. Publication Nos. US-2021-0155167 and/or US-2019-0118717, and/or International Publication No. WO 2022/150826, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular exterior rearview mirror assembly, the vehicular exterior rearview mirror assembly comprising:
a mirror head adjustable about a mounting structure, wherein the mounting structure is configured to mount the vehicular exterior rearview mirror assembly at a side of a vehicle;
wherein the mirror head accommodates a mirror reflective element;
wherein, with the vehicular exterior rearview mirror assembly mounted at the side of the vehicle, the mirror head is movable relative to the mounting structure between at least (i) an extended position where the mirror head is extended outward from the side of the vehicle so that the mirror reflective element is positioned to provide a rearward view at the side of the vehicle for a driver of the vehicle and (ii) a folded position where the mirror head is folded inward from the extended position toward the side of the vehicle;
an actuator, wherein, with the vehicular exterior rearview mirror assembly mounted at the side of the vehicle, the actuator is electrically operable to move the mirror head relative to the mounting structure between the folded position and the extended position;
wherein the actuator comprises a detent that, when engaged, retains the mirror head in the extended position or the folded position;
wherein a pivot tube extends from the mounting structure and through a base portion of the actuator, and wherein, while the mirror head moves between the extended position and the folded position, the mirror head moves about the pivot tube;
wherein, when the mirror head is moved from the extended position toward the folded position, the mirror head moves along a longitudinal axis of the pivot tube away from the mounting structure and the base portion of the actuator;
wherein a position sensor is disposed at one selected from the group consisting of (i) a movable portion of the actuator and (ii) a static portion of the actuator;
wherein a magnetic element is disposed at the other one of (i) the movable portion of the actuator and (ii) the static portion of the actuator;
wherein, when the mirror head is moved between the extended position and the folded position, (i) the movable portion of the actuator moves relative to the pivot tube according to movement of the mirror head relative to the pivot tube, (ii) the static portion of the actuator does not move relative to the pivot tube and (iii) the position sensor and the magnetic element move relative to one another according to movement of the movable portion of the actuator relative to the static portion of the actuator; and
wherein the position sensor senses change in a magnetic field caused by relative movement of the position sensor and the magnetic element for determining a position of the mirror head about the pivot tube.

2. The vehicular exterior rearview mirror assembly of claim 1, wherein the position sensor is disposed at the movable portion of the actuator, and wherein the magnetic element is disposed at the static portion of the actuator.

3. The vehicular exterior rearview mirror assembly of claim 2, wherein the movable portion of the actuator comprises a housing of the actuator, and wherein the position sensor is accommodated by a printed circuit board (PCB) within the housing of the actuator.

4. The vehicular exterior rearview mirror assembly of claim 1, wherein the position sensor is disposed at the static portion of the actuator, and wherein the magnetic element is disposed at the movable portion of the actuator.

5. The vehicular exterior rearview mirror assembly of claim 1, wherein the static portion of the actuator comprises the base portion.

6. The vehicular exterior rearview mirror assembly of claim 1, wherein the static portion of the actuator comprises a retainer flange at an upper end region of the pivot tube.

7. The vehicular exterior rearview mirror assembly of claim 1, wherein the position sensor and the magnetic element are spaced from one another in a direction parallel to the longitudinal axis of the pivot tube.

8. The vehicular exterior rearview mirror assembly of claim 7, wherein, with the mirror head in the extended position, the position sensor and the magnetic element are aligned with one another in the direction parallel to the longitudinal axis of the pivot tube.

9. The vehicular exterior rearview mirror assembly of claim 7, wherein, with the vehicular exterior rearview mirror assembly mounted at the side of the vehicle, the position sensor is disposed above the magnetic element.

10. The vehicular exterior rearview mirror assembly of claim 1, wherein the position sensor and the magnetic element are spaced from one another on a plane that is perpendicular to the longitudinal axis of the pivot tube.

11. The vehicular exterior rearview mirror assembly of claim 10, wherein, with the mirror head in the extended position, the position sensor, the magnetic element and the longitudinal axis of the pivot tube are aligned with one another on the plane that is perpendicular to the longitudinal axis of the pivot tube.

12. The vehicular exterior rearview mirror assembly of claim 10, wherein, with the vehicular exterior rearview mirror assembly mounted at the side of the vehicle, the position sensor is disposed radially outboard of the magnetic element.

13. The vehicular exterior rearview mirror assembly of claim 1, further comprising an electronic control unit (ECU) having electronic circuitry and associated software, and wherein the electronic circuitry includes a processor configured to process sensor data transmitted to the ECU, and wherein the position sensor transmits sensor data to the ECU representative of the sensed change in the magnetic field, and wherein the ECU determines the position of the mirror head about the pivot tube via processing of the sensor data transmitted from the position sensor.

14. The vehicular exterior rearview mirror assembly of claim 13, wherein the ECU is disposed remote from the vehicular exterior rearview mirror assembly.

15. The vehicular exterior rearview mirror assembly of claim 13, wherein the ECU is accommodated by the actuator, and wherein, responsive to determining the position of the mirror head about the pivot tube, the ECU transmits a signal to a control module for a system of the vehicle that is disposed remote from the vehicular exterior rearview mirror assembly.

16. The vehicular exterior rearview mirror assembly of claim 15, wherein the signal comprises one selected from the group consisting of (i) a discrete signal and (ii) an analog signal.

17. The vehicular exterior rearview mirror assembly of claim 1, wherein the position sensor comprises a Hall effect sensor, and wherein the magnetic element comprises a magnet, and wherein the Hall effect sensor senses change in a magnetic field of the magnet for determining the position of the mirror head about the pivot tube.

18. The vehicular exterior rearview mirror assembly of claim 17, wherein an axis extending through a north pole of the magnet and a south pole of the magnet (i) extends perpendicular to the longitudinal axis of the pivot tube and (ii) intersects the longitudinal axis of the pivot tube.

19. The vehicular exterior rearview mirror assembly of claim 17, wherein an axis extending through a north pole of the magnet and a south pole of the magnet (i) extends perpendicular to the longitudinal axis of the pivot tube and (ii) extends offset from the longitudinal axis of the pivot tube.

20. The vehicular exterior rearview mirror assembly of claim 19, wherein the axis extending through the north pole of the magnet and the south pole of the magnet extends tangential to a path of motion of the mirror head between the extended position and the folded position.

21. The vehicular exterior rearview mirror assembly of claim 1, wherein the position sensor comprises an induction sensor, and wherein the magnetic element comprises one selected from the group consisting of (i) a magnet and (ii) a magnetic material, and wherein the induction sensor senses change in a magnetic field generated by the induction sensor for determining the position of the mirror head about the pivot tube.

22. A vehicular exterior rearview mirror assembly, the vehicular exterior rearview mirror assembly comprising:
a mirror head adjustable about a mounting structure, wherein the mounting structure is configured to mount the vehicular exterior rearview mirror assembly at a side of a vehicle;
wherein the mirror head accommodates a mirror reflective element;
wherein, with the vehicular exterior rearview mirror assembly mounted at the side of the vehicle, the mirror head is movable relative to the mounting structure between at least (i) an extended position where the mirror head is extended outward from the side of the vehicle so that the mirror reflective element is positioned to provide a rearward view at the side of the vehicle for a driver of the vehicle and (ii) a folded position where the mirror head is folded inward from the extended position toward the side of the vehicle;
an actuator, wherein, with the vehicular exterior rearview mirror assembly mounted at the side of the vehicle, the actuator is electrically operable to move the mirror head relative to the mounting structure between the folded position and the extended position;
wherein the actuator comprises a detent that, when engaged, retains the mirror head in the extended position or the folded position;
wherein a pivot tube extends from the mounting structure and through a base portion of the actuator, and wherein, while the mirror head moves between the extended position and the folded position, the mirror head moves about the pivot tube;
wherein, when the mirror head is moved from the extended position toward the folded position, the mirror head moves along a longitudinal axis of the pivot tube away from the mounting structure and the base portion of the actuator;
wherein a Hall effect sensor is disposed at a movable portion of the actuator;
wherein a magnet is disposed at a static portion of the actuator;
wherein, when the mirror head is moved between the extended position and the folded position, (i) the movable portion of the actuator moves relative to the pivot tube according to movement of the mirror head relative to the pivot tube, (ii) the static portion of the actuator does not move relative to the pivot tube and (iii) the Hall effect sensor and the magnet move relative to one another according to movement of the movable portion of the actuator relative to the static portion of the actuator;
wherein the Hall effect sensor senses change in a magnetic field of the magnet caused by relative movement of the Hall effect sensor and the magnet;
an electronic control unit (ECU);
wherein the ECU comprises electronic circuitry and associated software, and wherein the electronic circuitry includes a processor configured to process sensor data transmitted to the ECU;
wherein the Hall effect sensor transmits sensor data to the ECU representative of the sensed change in the magnetic field; and
wherein the ECU determines a position of the mirror head about the pivot tube via processing of the sensor data transmitted from the Hall effect sensor.

23. The vehicular exterior rearview mirror assembly of claim 22, wherein the static portion of the actuator comprises one selected from the group consisting of (i) the base portion and (ii) a retainer flange at an upper end region of the pivot tube.

24. The vehicular exterior rearview mirror assembly of claim 22, wherein, with the vehicular exterior rearview mirror assembly mounted at the side of the vehicle, the Hall effect sensor is disposed radially outboard of the magnet.

25. A vehicular exterior rearview mirror assembly, the vehicular exterior rearview mirror assembly comprising:
a mirror head adjustable about a mounting structure, wherein the mounting structure is configured to mount the vehicular exterior rearview mirror assembly at a side of a vehicle;
wherein the mirror head accommodates a mirror reflective element;
wherein, with the vehicular exterior rearview mirror assembly mounted at the side of the vehicle, the mirror head is movable relative to the mounting structure between at least (i) an extended position where the mirror head is extended outward from the side of the vehicle so that the mirror reflective element is positioned to provide a rearward view at the side of the vehicle for a driver of the vehicle and (ii) a folded position where the mirror head is folded inward from the extended position toward the side of the vehicle;
an actuator, wherein, with the vehicular exterior rearview mirror assembly mounted at the side of the vehicle, the actuator is electrically operable to move the mirror head relative to the mounting structure between the folded position and the extended position;
wherein the actuator comprises a detent that, when engaged, retains the mirror head in the extended position or the folded position;
wherein a pivot tube extends from the mounting structure and through a base portion of the actuator, and wherein, while the mirror head moves between the extended position and the folded position, the mirror head moves about the pivot tube;
wherein, when the mirror head is moved from the extended position toward the folded position, the mirror head moves along a longitudinal axis of the pivot tube away from the mounting structure and the base portion of the actuator;
wherein an induction sensor is disposed at a movable portion of the actuator, and wherein the induction sensor generates a magnetic field;
wherein a magnetic element is disposed at a static portion of the actuator, and wherein the magnetic element comprises one selected from the group consisting of (i) a magnet and (ii) a magnetic material;
wherein, when the mirror head is moved between the extended position and the folded position, (i) the movable portion of the actuator moves relative to the pivot tube according to movement of the mirror head relative to the pivot tube, (ii) the static portion of the actuator does not move relative to the pivot tube and (iii) the induction sensor and the magnetic element move relative to one another according to movement of the movable portion of the actuator relative to the static portion of the actuator;
wherein the induction sensor senses change in the magnetic field caused by relative movement of the induction sensor and the magnetic element;
an electronic control unit (ECU), wherein the ECU is disposed remote from the vehicular exterior rearview mirror assembly;
wherein the ECU comprises electronic circuitry and associated software, and wherein the electronic circuitry includes a processor configured to process sensor data transmitted to the ECU;
wherein the induction sensor transmits sensor data to the ECU representative of the sensed change in the magnetic field; and
wherein the ECU determines a position of the mirror head about the pivot tube via processing of the sensor data transmitted from the induction sensor.

26. The vehicular exterior rearview mirror assembly of claim 25, wherein the static portion of the actuator comprises one selected from the group consisting of (i) the base portion and (ii) a retainer flange at an upper end region of the pivot tube.

27. The vehicular exterior rearview mirror assembly of claim 25, wherein the induction sensor and the magnetic element are spaced from one another in a direction parallel to the longitudinal axis of the pivot tube.

28. The vehicular exterior rearview mirror assembly of claim 25, wherein the induction sensor and the magnetic element are spaced from one another on a plane that is perpendicular to the longitudinal axis of the pivot tube.
